(19) United States
(12) Patent Application Publication
(10) Pub. No.: US 2014/0373571 A1
(43) Pub. Date: Dec. 25, 2014

(54) FUSED SILICA GLASS ARTICLE HAVING IMPROVED RESISTANCE TO LASER DAMAGE

(71) Applicant: Corning Incorporated, Corning, NY (US)

(72) Inventors: Kenneth Edward Hrdina, Horseheads, NY (US); Changyi Lai, Painted Post, NY (US); Lisa Anne Moore, Corning, NY (US); Ulrich Wilhelm Heinz Neukirch, Painted Post, NY (US); William Rogers Rosch, Corning, NY (US)

(73) Assignee: Corning Incorporated, Corning, NY (US)

(21) Appl. No.: 14/269,409

(22) Filed: May 5, 2014

Related U.S. Application Data
(60) Provisional application No. 61/836,695, filed on Jun. 19, 2013.

(51) Int. Cl. C03C 23/00

(52) U.S. Cl. CPC C03C 23/0095
USPC 65/32.1

(57) ABSTRACT

A fused silica glass article having greater resistance to damage induced by exposure to laser radiation such as laser induced wavefront distortion at deep ultraviolet (DUV) wavelengths, and behaviors such as fluence dependent transmission, which are related to intrinsic defects in the glass. The improved resistance to laser damage may be achieved in some embodiments by loading the glass article with molecular hydrogen (H₂) at temperatures of about 400° C. or less, or 350° C. or less. The combined OH and deuteroxyl (OD) concentration may be less than 10 ppm by weight. In other embodiments, the improved resistance may be achieved by providing the glass with 10 to 60 ppm deuteroxyl (OD) species by weight. In still other embodiments, improved resistance to such laser damage may be achieved by both loading the glass article with molecular hydrogen at temperatures of about 350° C. or less and providing the glass with less than 10 ppm combined OH and OD, or 10 to 60 ppm OD by weight.

This application claims the benefit of priority under 35 U.S.C. §119 of U.S. Provisional Application Ser. No. 61/836,695 filed on Jun. 19, 2013 the content of which is relied upon and incorporated herein by reference in its entirety.

### BACKGROUND

The disclosure relates to fused silica glass articles having improved resistance to damage induced by exposure to deep ultraviolet laser radiation. More particularly, the disclosure relates to fused silica glass articles having low levels of laser induced wavefront distortion and fluence dependent transmission and to methods of making such articles, including methods based on H₂ loading at temperatures of 400° C. or less.

Optical components and materials used in the semiconductor industry, particularly in the area of photolithography, have increasingly stringent requirements for Laser Induced Wavefront Distortion (LIWFD), as increasing output energy densities per pulse and higher repetition rates are used in deep ultraviolet (DUV) 193 nm ArF steppers. This also increases the required density of molecular hydrogen in the lenses of such steppers. While the laser resistance behavior of optical materials has been improved to some extent with improved glass making and hydrogen loading processes, some aspects of these processes adversely impact laser resistance performance.

### SUMMARY

The present disclosure provides a fused silica glass article having greater resistance to damage induced by exposure to laser radiation such as laser induced wavefront distortion at deep ultraviolet (DUV) wavelengths, and behaviors such as fluence dependent transmission, which are related to intrinsic defects in the glass. The improved resistance to laser damage may be achieved in some embodiments by loading the glass article with molecular hydrogen (H₂) at temperatures of about 350° C. or less. In other embodiments, the improved resistance may be achieved by providing the glass with 10 to 60 ppm deuteroxyl (OD) species by weight. In still other embodiments, improved resistance to such laser damage may be achieved by both loading the glass article with molecular hydrogen at temperatures of about 350° C. or less and providing the glass with 10 to 60 ppm OD by weight.

Accordingly, one aspect of the disclosure is to provide a fused silica glass article comprising less than about 5×10¹⁷ H₂ molecules/cm³. The fused silica glass article has a laser induced wavefront distortion of less than 0.7 nm/cm measured at 633 nm and less than 1.4 nm/cm measured at 193 nm after exposure to 9 billion pulses of 193 nm wavelength laser radiation at a fluence of 200 μJ/cm² per pulse and a pulse width of about 22 ns. The fused silica glass article is also free of chlorine and fluorine.

A second aspect is to provide a fused silica glass article comprising less than about 5×10¹⁷ H₂ molecules/cm³ and at least one of OH and OD groups. The OH and the OD groups are present in the fused silica glass article in a combined concentration in a range from about 10 ppm to less than about 60 ppm by weight. The fused silica glass article has a laser induced wavefront distortion of less than 0.7 nm/cm measured at 633 nm and less than 1.4 nm/cm measured at 193 nm after exposure to 9 billion pulses of 193 nm wavelength laser radiation at a fluence of 200 μJ/cm² per pulse and a pulse width of about 22 ns, wherein the fused silica glass article is free of chlorine and fluorine.

A third aspect is to provide a fused silica glass article comprising less than about 5×10¹⁷ H₂ molecules/cm³, wherein the fused silica glass article is loaded with H₂ at a temperature less than or equal to about 350° C. The fused silica glass article has a laser induced wavefront distortion of less than 1.25 nm/cm measured at 633 nm, and less than 2.5 nm/cm measured at 193 nm after exposure to 9 billion pulses of 193 nm wavelength laser radiation at a fluence of 200 μJ/cm² per pulse and a pulse width of about 24 ns. The fused silica glass article is also free of chlorine and fluorine.

A fourth aspect is to provide a fused silica glass article comprising less than about 5×10¹⁷ H₂ molecules/cm³, wherein the fused silica glass article is free of chlorine and fluorine. The fused silica glass article has a fluence dependent transmission of less than 1.3×10⁻⁵ cm-pulse/mJ after exposure of up to 4 million pulses of 193 nm laser radiation with a fluence of 1 mJ/cm² per pulse to about 10 mJ/cm² per pulse and a repetition rate of 400 Hz.

A fifth aspect is to provide a fused silica glass article comprising less than about 1×10¹⁷ H₂ molecules/cm³ and at least one of OH and OD groups. The OH and OD groups are present in the fused silica glass in a combined concentration of less than 10 ppm, or less than 5 ppm, or less than 1 ppm. The fused silica glass article has a laser induced wavefront distortion of less than 2.5 nm/cm measured at 633 nm and less than 4.0 nm/cm measured at 193 nm after exposure to 6 billion pulses of 193 nm wavelength laser radiation at a fluence of 500 μJ/cm² per pulse and a pulse width of 24 ns. The fused silica glass article is also free of chlorine and fluorine.

A sixth aspect is to provide a fused silica glass article comprising a minimum concentration of H₂ throughout the glass article greater than about 1.0×10¹⁶ H₂ molecules/cm³, or a minimum concentration of H₂ throughout the glass article greater than about 3.0×10¹⁶ H₂ molecules/cm³, or a minimum concentration of H₂ throughout the glass article greater than about 5.0×10¹⁶ H₂ molecules/cm³, or a minimum concentration of H₂ throughout the glass article greater than about 1.0×10¹⁷ H₂ molecules/cm³ and at least one of OH and OD groups. The OH and OD groups are present in the fused silica glass in a combined concentration of less than 10 ppm, or less than 5 ppm, or less than 1 ppm. The fused silica glass article has a laser induced wavefront distortion of less than 1.7 nm/cm measured at 633 nm and less than 3.0 nm/cm measured at 193 nm after exposure to 6 billion pulses of 193 nm wavelength laser radiation at a fluence of 500 μJ/cm² per pulse and a pulse width of 80 ns. The fused silica glass article is also free of chlorine and fluorine.

A seventh aspect is to provide a fused silica glass article comprising a minimum concentration of H₂ throughout the glass article greater than about 1.0×10¹⁶ H₂ molecules/cm³, or a minimum concentration of H₂ throughout the glass article greater than about 3.0×10¹⁶ H₂ molecules/cm³, or a minimum concentration of H₂ throughout the glass article greater than about 5.0×10¹⁶ H₂ molecules/cm³, or a minimum concentration of H₂ throughout the glass article greater than about 1.0×10¹⁷ H₂ molecules/cm³ and at least one of OH and OD groups. The OH and OD groups are present in the fused silica glass in a combined concentration of less than 10 ppm, or less than 5 ppm, or less than 1 ppm. The fused silica glass article has a laser induced wavefront distortion of less than 1.7 nm/cm measured at 633 nm and less than 3.0 nm/cm measured at 193 nm after exposure to 12 billion pulses of 193 nm wavelength laser radiation at a fluence of 200 μJ/cm² per pulse and a pulse width of 24 ns. The fused silica glass article is also free of chlorine and fluorine.

An eighth aspect is to provide a fused silica glass article comprising less than about 1×10¹⁷ H₂ molecules/cm³ and at least one of OH and OD groups, where the hydrogen is loaded at a temperature of less than or equal to 350° C. The OH and OD groups are present in the fused silica glass in a combined concentration of less than 10 ppm, or less than 5 ppm, or less than 1 ppm. The fused silica glass article has a laser induced wavefront distortion of less than 2.5 nm/cm measured at 633 nm and less than 4.0 nm/cm measured at 193 nm after exposure to 6 billion pulses of 193 nm wavelength laser radiation at a fluence of 500 μJ/cm² per pulse and a pulse width of 24 ns. The fused silica glass article is also free of chlorine and fluorine.

A ninth aspect is to provide a fused silica glass article comprising a minimum concentration of H₂ throughout the glass article greater than about 1.0×10¹⁶ H₂ molecules/cm³, or a minimum concentration of H₂ throughout the glass article greater than about 3.0×10¹⁶ H₂ molecules/cm³, or a minimum concentration of H₂ throughout the glass article greater than about 5.0×10¹⁶ H₂ molecules/cm³, or a minimum concentration of H₂ throughout the glass article greater than about 1.0×10¹⁷ H₂ molecules/cm³ and at least one of OH and OD groups, where the hydrogen is loaded at a temperature less than or equal to about 350° C. The OH and OD groups are present in the fused silica glass in a combined concentration of less than 10 ppm, or less than 5 ppm, or less than 1 ppm. The fused silica glass article has a laser induced wavefront distortion of less than 1.7 nm/cm measured at 633 nm and less than 3.0 nm/cm measured at 193 nm after exposure to 6 billion pulses of 193 nm wavelength laser radiation at a fluence of 500 μJ/cm² per pulse and a pulse width of 80 ns. The fused silica glass article is also free of chlorine and fluorine.

A tenth aspect is to provide a fused silica glass article comprising a minimum concentration of H₂ throughout the glass article greater than about 1.0×10¹⁶ H₂ molecules/cm³, or a minimum concentration of H₂ throughout the glass article greater than about 3.0×10¹⁶ H₂ molecules/cm³, or a minimum concentration of H₂ throughout the glass article greater than about 5.0×10¹⁶ H₂ molecules/cm³, or a minimum concentration of H₂ throughout the glass article greater than about 1.0×10¹⁷ H₂ molecules/cm³ and at least one of OH and OD groups, where the hydrogen is loaded at a temperature less than or equal to about 350° C. The OH and OD groups are present in the fused silica glass in a combined concentration of less than 10 ppm, or less than 5 ppm, or less than 1 ppm. The fused silica glass article has a laser induced wavefront distortion of less than 1.7 nm/cm measured at 633 nm and less than 3.0 nm/cm measured at 193 nm after exposure to 12 billion pulses of 193 nm wavelength laser radiation at a fluence of 200 μJ/cm² per pulse and a pulse width of 24 ns. The fused silica glass article is also free of chlorine and fluorine.

These and other aspects, advantages, and salient features will become apparent from the following detailed description, the accompanying drawings, and the appended claims.

### BRIEF DESCRIPTION OF THE DRAWINGS

FIG. 1a is a plot of laser induced wavefront distortion (LIWFD) after exposure to a 500 μJ/cm² unstretched 193 nm laser beam and measured at 633 nm for sample 17395ALD3 and reference samples.

FIG. 1b is a plot of LIWFD after exposure to a 500 μJ/cm² unstretched 193 nm laser beam and measured at 193 nm for sample 17395ALD3 and reference samples.

FIG. 2a is a plot of LIWFD after exposure to a 500 μJ/cm² unstretched 193 nm laser beam and measured at 633 nm for sample 17119LDD1.

FIG. 2b is a plot of LIWFD after exposure to a 500 μJ/cm² unstretched 193 nm laser beam and measured at 193 nm for sample 17119LDD1.

FIG. 3a is a plot of normalized LIWFD measured at 633 nm for samples 17119LDD1, 17119LDE1, 17119LDE2, and reference samples; and

FIG. 3b is a plot of normalized LIWFD measured at 633 nm for samples 17119LDD1, 17119LDE1, 17119LDE2, and reference samples.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

As used herein, the terms “glass article” and “glass articles” are used in their broadest sense to include any object made wholly or partly of glass. It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Referring to the drawings, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

As used herein, “protium” refers to the hydrogen isotope having a mass number of 1 and consisting of a single proton and electron. The symbol “H” refers to protium (₁¹H) atoms, unless otherwise specified. As used herein, the term n(H) refers to the total number of protium atoms in a material.

As used herein, the terms “hydroxyl” and “OH” refer to a moiety or a group of moieties each consisting of an oxygen atom and a protium atom (₁¹H, referred to herein as “H”), unless otherwise specified. As used herein, n(OH) means the total number of OH or hydroxyl moieties in a material.

As used herein, “deuterium” refers to the hydrogen isotope having one proton and one neutron in its nucleus, and having an atomic weight of 2.0144. The symbols “D” and “D₂” refer to deuterium (₁²H) atoms and molecules, respectively, unless otherwise specified. As used herein, the term n(D) refers to the total number of deuterium atoms in a material.

As used herein, the term “deuteroxyl(s)” and “OD” refer to a moiety or a group of moieties, each consisting of an oxygen atom and a deuterium atom (₁²H or ₁²D, referred to herein as “D”). As used herein, n(OD) means the total number of OD moieties in a material. When hydroxyl and deuteroxyl groups are present in their natural isotopic abundance, the ratio of n(OD)/(n(OD)+n(OH)) in the material is equal to about 2×10⁻⁴.

As used herein, the terms “hydrogen,” “molecular hydrogen,” and “H₂” refer to the naturally occurring mixture of protium and deuterium molecules and atoms (99.98% protium and 0.02% deuterium), unless otherwise stated.

As used herein, the term “hydrogen species” refers to any combination of the naturally occurring isotopes of hydrogen. Unless otherwise stated, hydrogen species include, for example: the naturally occurring mixture of protium and deuterium atoms and molecules; any other mixture of protium and deuterium atoms, molecules, and mixtures thereof; pure protium atoms, molecules, and mixtures thereof; and pure deuterium atoms, molecules, and mixtures thereof, unless otherwise stated.

Unless otherwise specified, when reference is made to any element other than hydrogen, it is understood that the element is present in its naturally occurring state; i.e., the isotopic distribution of the element is that which occurs in nature, and the element is not enriched in any one isotope.

When referring to the concentration of hydrogen in the fused silica glass article, it is recognized that hydrogen may not be uniformly distributed throughout the glass article and that concentration gradients may be present. The process of loading hydrogen into the glass article may include exposing the glass article to a gaseous environment containing one or more gases, one of which is hydrogen. In such a process, loading of hydrogen into the glass article may occur primarily through a diffusion process and a gradient in hydrogen concentration may be present in which the concentration of hydrogen is higher near the surface of the glass article than near the center of the glass article. The concentration of hydrogen in the glass article may accordingly be described in terms of a minimum concentration of hydrogen, where the concentration of hydrogen throughout the glass article is at or above the minimum concentration of hydrogen.

When exposed to pulsed ultraviolet (UV) excimer laser radiation, silica glasses undergo optical changes that may include either an increase or decrease in optical path. Optical path changes produced by exposure to radiation having a wavelength of 193 nm are typically on the order of magnitude of about 1 ppm per unit length. In many instances, the permanent structural change produced by exposure to a 193 nm ArF excimer laser typically results in an increase in optical path length, which is attributed to an increase in density and a correlated increase in refractive index of the glass. This compaction, which follows an empirical power law behavior as a function of laser fluence, is evidenced by laser induced wavefront distortion (LIWFD).

Additionally, transient absorption (k) of synthetic silica glass in the UV region is dependent on the fluence (F or h, expressed in terms of mJ/cm²·pulse) of the UV irradiation to which the glass is exposed. The relationship between the transient absorption k of the glass and radiation fluence F can generally be represented by a least-squares linear fitting curve of the measured absorption and fluence data. Thus, as used herein, fluence-dependent transmission (FDT) is defined as the slope of the linear fitting curve (dk/dF or dk/dh). FDT is measured by exposing fused silica glass to pulsed UV excimer laser radiation having a wavelength of 193 nm and a repetition rate of around 400 Hz, and measuring the transmitted light for two or more fluences ranging from 1 mJ/cm²·pulse to about 10 mJ/cm²·pulse. Absorption (k) of the glass is calculated from the measured internal transmission (Tᵢ, expressed in terms of percentage per cm):

k=2−log Tᵢ.

For example, the absorption k₁ of a glass having an internal transmission T_{i,1} of 99.00% is calculated as follows:

k₁=2−log T_{i,1}=2−log 99.00=2−1.996=0.004

For the FDT measurements described herein, the internal transmission (Tᵢ) is the measured transmission at 193 nm, corrected for surface reflection losses and normalized to a 1 cm path length after exposing the glass to a predetermined number of pulses of excimer laser radiation at 193 nm at varying fluences. The method of determining FDT is described in described in U.S. Pat. No. 7,928,026, by Dana Craig Bookbinder et al., filed Oct. 28, 2005, and entitled “Synthetic Silica Material with Low Fluence-Dependent-Transmission and Method of Making the Same,” which claims priority from U.S. provisional patent application No. 60/696,105, filed Jun. 30, 2005, and having the same title, the contents of which are incorporated by reference herein in their entirety.

Described herein is a fused silica glass article having reduced laser induced wavefront distortion and/or fluence dependent transmission. The fused silica glass article is free of chlorine, fluorine, and bromine, and comprises less than about 5×10¹⁷ H₂ molecules/cm³.

In some embodiments, the fused silica glass article comprises at least one of hydroxyl (OH) and deuteroxyl (OD) groups in a combined concentration in a range from about 10 ppm to about 60 ppm by weight and, in some embodiments, from about 20 ppm to about 40 ppm by weight. In other embodiments, OH and OD are present in the fused silica glass article in a combined concentration of less than about 60 ppm by weight, or less than 10 ppm by weight, or less than 5 ppm by weight, or less than 1 ppm by weight. In some embodiments, the ratio of OD concentration to the combined OH and OD concentration is greater than the naturally occurring isotopic abundance of deuterium; i.e., the ratio n(OD)/(n(OD)+n(OH)) in the material is greater than 2×10⁴. In certain embodiments, the above ratio of OD concentration to the combined concentration of OH and OD is at least 0.5, at least 0.8 in some embodiments, at least 0.9 in other embodiments, and at least 0.95 in still other embodiments.

The fused silica glass article may, in some embodiments, comprise less than about 1×10¹⁷ H₂ molecules/cm³. In certain embodiments, the fused silica glass article comprises from about 0.3×10¹⁷ H₂ molecules/cm³ to about 3×10¹⁷ H₂ molecules/cm³. In some embodiments, the fused silica glass article is loaded with hydrogen by heating the article in a hydrogen-containing atmosphere at a temperature (or temperatures) of up to about 350° C., in some embodiments at a temperature (or temperatures) of up to about 370° C., in some embodiments (or temperatures) of up to about 400° C., in still other embodiments, at temperatures (or temperatures) of up to about 450° C., and, in other embodiments, at temperatures (or temperatures) of up to about 475° C.

In some embodiments, the fused silica glass article described herein contain less than 5 parts per billion (ppb) of metal impurities (e.g., Na, K, Al, or the like) by weight.

In certain embodiments, the fused silica glass article described herein has a laser induced wavefront distortion (LIWFD) of less than 2.5 nm/cm when measured at a wavelength of 633 nm, and/or less than 4 nm/cm when measured at a wavelength of 193 nm, following 6 billion pulses of exposure to 193 nm wavelength laser radiation at a fluence of 500 μJ/cm² per pulse and a pulse width of approximately 24 ns. The glass article has a H₂ content of less than 1×10¹⁷ molecules/cm³ and, in some embodiments, less than 5×10¹⁶ molecules/cm³. Here, the glass article comprises less than 10 ppm OH and, in some embodiments, less than 1 ppm OH by weight. The OD concentration of the fused silica glass article is less than 80 ppm and, in some embodiments, less than 10 ppm, and in still other embodiments, less than 5 ppm by weight.

In certain embodiments, the fused silica glass article has a LIWFD of less than 2 nm/cm when measured at a wavelength of 633 nm and/or less than 3 nm/cm when measured at a wavelength of 193 nm after exposure to 6 billion pulses of 193 nm wavelength laser radiation at a fluence of 500 μJ/cm² per pulse and a pulse width of approximately 80 ns, and comprises less than 5×10¹⁷ H₂ molecules/cm³ and, in some embodiments, less than 3×10¹⁷ H₂ molecules/cm³. Here, the OH content of the fused silica glass article is less than 10 ppm and, in some embodiments, less than 1 ppm by weight, and the OD content of the fused silica glass article is, in some embodiments, less than 80 ppm, in other embodiments, less than 10 ppm, and, in still other embodiments, less than 5 ppm by weight.

In certain embodiments, the fused silica glass article has a LIWFD of less than 2 nm/cm, when measured at a wavelength of 633 nm, and/or less than 3.5 nm/cm measured when measured at a wavelength of 193 nm after exposure to 12 billion pulses of 193 nm wavelength laser radiation at a fluence of 200 μJ/cm² per pulse and a pulse width of approximately 24 ns, and comprises less than 5×10¹⁷ H₂ molecules/cm³ and, in some embodiments, less than 3×10¹⁷ H₂ molecules/cm³. Here, the fused silica glass article comprises less than 10 ppm OH and, in some embodiments, less than 1 ppm OH by weight. The fused silica glass article comprises, in some embodiments, less than 80 ppm OD, in other embodiments, less than 10 ppm OD, and, in still other embodiments, less than 5 ppm OD by weight.

In certain other embodiments, the fused silica glass article has a LIWFD of less than 2 nm/cm when measured at a wavelength of 633 nm, and/or less than 3 nm/cm measured at a wavelength of 193 nm after exposure to 6 billion pulses of 193 nm wavelength laser radiation at a fluence of 500 μJ/cm² per pulse and a pulse width of approximately 22 ns. The fused silica glass article comprises less than 1×10¹⁷ H₂ molecules/cm³ and, in some embodiments, less than 5×10¹⁶ H₂ molecules/cm³. The fused silica glass article comprises less than 10 ppm OH and, in some embodiments, less than 1 ppm OH by weight. The OD concentration of the fused silica glass is, in some embodiments, about 20 ppm by weight. In other embodiments, the fused silica glass article comprises less than 60 ppm and greater than 1 ppm OD by weight.

In certain other embodiments, the fused silica glass described herein has a LIWFD of less than 1.5 nm/cm when measured at a wavelength of 633 nm, and/or less than 2 nm/cm when measured at a wavelength of 193 nm after exposure to 6 billion pulses of 193 nm wavelength laser radiation at a fluence of 500 μJ/cm² per pulse and a pulse width of approximately 87 ns. Here, the fused silica glass article comprises less than 5×10¹⁷ H₂ molecules/cm³ and, in some embodiments, less than 3×10¹⁷ H₂. The fused silica glass article comprises less than 10 ppm OH and, in some embodiments, less than 1 ppm OH by weight. The OD concentration of the fused silica glass is, in some embodiments, about 20 ppm by weight. In other embodiments, the fused silica glass article comprises less than 60 ppm and greater than 1 ppm OD by weight.

In certain other embodiments, the fused silica glass described herein has a LIWFD of less than 1.3 nm/cm measured at a wavelength of 633 nm and/or less than 2.1 nm/cm measured at a wavelength of 193 nm after exposure to 9 billion pulses of 193 nm wavelength laser radiation at a fluence of 200 μJ/cm² per pulse and a pulse width of approximately 18 ns. Here, the fused silica glass article comprises less than 5×10¹⁷ H₂ molecules/cm³ and, in some embodiments, less than 3×10¹⁷ H₂ molecules/cm³. The fused silica glass article comprises less than 10 ppm OH and, in some embodiments, less than 1 ppm OH by weight. The OD concentration of the fused silica glass is, in some embodiments, about 20 ppm by weight. In other embodiments, the fused silica glass article comprises less than 60 ppm and greater than 1 ppm OD by weight.

In certain other embodiments, the fused silica glass described herein has a LIWFD of less than 0.7 nm/cm measured at a wavelength of 633 nm and/or less than 1.4 nm/cm measured at a wavelength of 193 nm after exposure to 9 billion pulses of 193 nm wavelength laser radiation at a fluence of 200 μJ/cm² per pulse and a pulse width of approximately 22 ns. Here, the fused silica glass article comprises less than 2×10¹⁷ H₂ molecules/cm³ and, in some embodiments, less than 1×10¹⁷ H₂ molecules/cm³. The fused silica glass article comprises less than 10 ppm OH and, in some embodiments, less than 1 ppm OH by weight. The OD concentration of the fused silica glass is, in some embodiments, about 20 ppm by weight. In other embodiments, the fused silica glass article comprises less than 60 ppm and greater than 1 ppm OD by weight.

In certain other embodiments, the fused silica glass described herein has a LIWFD of less than 2.5 nm/cm, or less than 2.3 nm/cm, or less than 2.1 nm/cm measured at 633 nm and/or less than 4.0 nm/cm, or less than 3.7 nm/cm, or less than 3.5 nm/cm, or less than 3.3 nm/cm measured at 193 nm after exposure to 6 billion pulses of 193 nm wavelength laser radiation at a fluence of 500 μJ/cm² per pulse and a pulse width of 24 ns. Here, the fused silica glass article comprises less than about 1×10¹⁷ H₂ molecules/cm³, or less than about 0.5×10¹⁶ H₂ molecules/cm³, and at least one of OH and OD groups. The OH and OD groups are present in the fused silica glass in a combined concentration of less than 10 ppm, or less than 5 ppm, or less than 1 ppm. The fused silica glass article is also free of chlorine and fluorine.

In certain other embodiments, the fused silica glass described herein has a LIWFD of less than 2.1 nm/cm, or less than 1.8 nm/cm, or less than 1.5 nm/cm measured at 633 nm and less than 3.5 nm/cm, or less than 3.2 nm/cm, or less than 3.0 nm/cm, or less than 2.7 nm/cm, or less than 2.5 nm/cm measured at 193 nm after exposure to 6 billion pulses of 193 nm wavelength laser radiation at a fluence of 500 μJ/cm² per pulse and a pulse width of 80 ns. Here, the fused silica glass article comprises a minimum concentration of H₂ throughout the glass article greater than about 1.0×10¹⁶ H₂ molecules/cm³, or a minimum concentration of H₂ throughout the glass article greater than about 3.0×10¹⁶ H₂ molecules/cm³, or a minimum concentration of H₂ throughout the glass article greater than about 5.0×10¹⁶ H₂ molecules/cm³, or a minimum concentration of H₂ throughout the glass article greater than about 1.0×10¹⁷ H₂ molecules/cm³, or a minimum concentration of H₂ throughout the glass article greater than about 1.5×10¹⁷ H₂ molecules/cm³, or a minimum concentration of H₂ throughout the glass article greater than about 2.0×10¹⁷ H₂ molecules/cm³, or a minimum concentration of H₂ throughout the glass article greater than about 2.5×10¹⁷ H₂ molecules/cm³, and at least one of OH and OD groups. The OH and OD groups are present in the fused silica glass in a combined concentration of less than 10 ppm, or less than 5 ppm, or less than 1 ppm. The fused silica glass article is also free of chlorine and fluorine.

In certain other embodiments, the fused silica glass described herein has a LIFWD of less than 2.1 nm/cm, or less than 1.9 nm/cm, or less than 1.7 nm/cm measured at 633 nm and less than 3.6 nm/cm, or less than 3.3 nm/cm, or less than 3.0 nm/cm measured at 193 nm after exposure to 12 billion pulses of 193 nm wavelength laser radiation at a fluence of 200 μJ/cm² per pulse and a pulse width of 24 ns. Here, the fused silica glass article comprises a minimum concentration of H₂ throughout the glass article greater than about 1.0×10¹⁶ H₂ molecules/cm³, or a minimum concentration of H₂ throughout the glass article greater than about 3.0×10¹⁶ H₂ molecules/cm³, or a minimum concentration of H₂ throughout the glass article greater than about 5.0×10¹⁶ H₂ molecules/cm³, or a minimum concentration of H₂ throughout the glass article greater than about 1.0×10¹⁷ H₂ molecules/cm³, or a minimum concentration of H₂ throughout the glass article greater than about 1.5×10¹⁷ H₂ molecules/cm³, or a minimum concentration of H₂ throughout the glass article greater than about 2.0×10¹⁷ H₂ molecules/cm³, or a minimum concentration of H₂ throughout the glass article greater than about 2.5×10¹⁷ H₂ molecules/cm³, and at least one of OH and OD groups. The OH and OD groups are present in the fused silica glass in a combined concentration of less than 10 ppm, or less than 5 ppm, or less than 1 ppm. The fused silica glass article is also free of chlorine and fluorine.

In certain other embodiments, the fused silica glass described herein has a LIFWD of less than 2.7 nm/cm, or less than 2.4 nm/cm, or less than 2.1 nm/cm measured at 633 nm and less than 4.0 nm/cm, or less than 3.7 nm/cm, or less than 3.5 nm/cm, or less than 3.3 nm/cm measured at 193 nm after exposure to 6 billion pulses of 193 nm wavelength laser radiation at a fluence of 500 μJ/cm² per pulse and a pulse width of 24 ns. Here, the fused silica glass article comprises less than about 1×10¹⁷ H₂ molecules/cm³, or less than about 0.5×10¹⁶ H₂ molecules/cm³, and at least one of OH and OD groups, where the hydrogen is loaded at a temperature of less than or equal to 400° C., or less than or equal to about 375° C., or less than or equal to about 350° C., or less than or equal to about 325° C. The OH and OD groups are present in the fused silica glass in a combined concentration of less than 10 ppm, or less than 5 ppm, or less than 1 ppm. The fused silica glass article is also free of chlorine and fluorine.

In certain other embodiments, the fused silica glass described herein has a LIFWD of less than 2.1 nm/cm, or less than 1.8 nm/cm, or less than 1.5 nm/cm measured at 633 nm and less than 3.5 nm/cm, or less than 3.2 nm/cm, or less than 3.0 nm/cm, or less than 2.7 nm/cm, or less than 2.5 nm/cm measured at 193 nm after exposure to 6 billion pulses of 193 nm wavelength laser radiation at a fluence of 500 μJ/cm² per pulse and a pulse width of 80 ns. Here, the fused silica glass article comprises a minimum concentration of H₂ throughout the glass article greater than about 1.0×10¹⁶ H₂ molecules/cm³, or a minimum concentration of H₂ throughout the glass article greater than about 3.0×10¹⁶ H₂ molecules/cm³, or a minimum concentration of H₂ throughout the glass article greater than about 5.0×10¹⁶ H₂ molecules/cm³, or a minimum concentration of H₂ throughout the glass article greater than about 1.0×10¹⁷ H₂ molecules/cm³, or a minimum concentration of H₂ throughout the glass article greater than about 1.5×10¹⁷ H₂ molecules/cm³, or a minimum concentration of H₂ throughout the glass article greater than about 2.0×10¹⁷ H₂ molecules/cm³, or a minimum concentration of H₂ throughout the glass article greater than about 2.5×10¹⁷ H₂ molecules/cm³, and at least one of OH and OD groups, where the hydrogen is loaded at a temperature less than or equal to about 400° C., or less than or equal to about 375° C., or less than or equal to about 350° C., or less than or equal to about 325° C. The OH and OD groups are present in the fused silica glass in a combined concentration of less than 10 ppm, or less than 5 ppm, or less than 1 ppm. The fused silica glass article is also free of chlorine and fluorine.

In certain other embodiments, the fused silica glass described herein has a LIFWD of less than 2.1 nm/cm, or less than 1.9 nm/cm, or less than 1.7 nm/cm measured at 633 nm and less than 3.6 nm/cm, or less than 3.3 nm/cm, or less than 3.0 nm/cm measured at 193 nm after exposure to 12 billion pulses of 193 nm wavelength laser radiation at a fluence of 200 μJ/cm² per pulse and a pulse width of 24 ns. Here, the fused silica glass article comprises a minimum concentration of H₂ throughout the glass article greater than about 1.0×10¹⁶ H₂ molecules/cm³, or a minimum concentration of H₂ throughout the glass article greater than about 3.0×10¹⁶ H₂ molecules/cm³, or a minimum concentration of H₂ throughout the glass article greater than about 5.0×10¹⁶ H₂ molecules/cm³, or a minimum concentration of H₂ throughout the glass article greater than about 1.0×10¹⁷ H₂ molecules/cm³, or a minimum concentration of H₂ throughout the glass article greater than about 1.5×10¹⁷ H₂ molecules/cm³, or a minimum concentration of H₂ throughout the glass article greater than about 2.0×10¹⁷ H₂ molecules/cm³, or a minimum concentration of H₂ throughout the glass article greater than about 2.5×10¹⁷ H₂ molecules/cm³, and at least one of OH and OD groups, where the hydrogen is loaded at a temperature less than or equal to about 400° C., or less than or equal to about 375° C., or less than or equal to about 350° C., or less than or equal to about 325° C. The OH and OD groups are present in the fused silica glass in a combined concentration of less than 10 ppm, or less than 5 ppm, or less than 1 ppm. The fused silica glass article is also free of chlorine and fluorine.

Methods of making the fused silica glasses described hereinabove are also provided. A silica soot blank—or preform—is first formed by methods known in the art such as, but not limited to, deposition methods in which a gas stream containing at least one silicon-containing precursor compound in vapor form is produced. Silicon precursor compounds include, but are not limited to, halogen-containing compounds such as SiCl₄, SiBr₄, SiF₄, and the like. Silicon precursor compounds also include, but are not limited to, halogen-free cyclosiloxane compounds such as, for example, polymethylsiloxanes. Such polymethylsiloxanes include hexamethyldisiloxane, polymethylcyclosiloxane, octamethylcyclotetrasiloxane (OMCTS), decamethylcyclopentasiloxane, hexamethylcyclotrisiloxane, and combinations thereof. Deposition methods that are typically used to form the soot blank include outside vapor deposition (OVD), planar soot deposition (PSD), vapor axial deposition (VAD) processes, and the like. The gas stream containing the silicon-containing compound is passed into the flame of a combustion burner to form amorphous particles of fused silica soot. The fused silica particles are deposited onto a support, such as a supporting core cane, a mandrel, or the like to form the silica soot blank. The support may be removed following deposition of the soot.

In those embodiments where a fused silica glass article comprising a predetermined concentration of deuteroxyl (OD) groups is desired, OD groups may be exchanged for hydroxyl (OH) groups in the soot blank using a process in which gases comprising up to 100% D₂O, or, preferably, 0.5-3% D₂O are flowed past the soot preform at temperatures in a range from about 500° C. up to about 1300° C. for a time period ranging from about 0.5 hours up to about 1000 hours. In one embodiment, the time period ranges from about 1 hour up to about 10 hours. In another embodiment, the gases comprising D₂O are flowed past the preform at temperatures in a range from about 1000° C. up to about 1200° C. In some embodiments, the process is carried out to obtain a predetermined OD concentration in a range from about 10 ppm to about 60 ppm by weight, in some embodiments, about 20 ppm by weight, in other embodiments, less than 60 ppm and greater than 1 ppm OD by weight, in other embodiments less than 80 ppm OD, in still other embodiments, less than 10 ppm OD, and, in still other embodiments, less than 5 ppm OD by weight.

The silica soot blank is then dried—i.e., dehydrated—by exposing the soot blank to carbon monoxide (CO) to reduce the combined concentration of OH and/or OD in the soot blank below a predetermined level. The silica soot blank is exposed to CO at a temperature in a range from about 900° C. up to about 1400° C. In one embodiment, the silica soot blank is exposed to CO at a temperature in a range from about 1200° C. up to about 1300° C. In one embodiment, the predetermined level of the combined concentration of OH and OD in the soot blank is less than about 10 ppm by weight. In another embodiment, the predetermined level of the combined concentration of OH and OD in the soot blank is less than about 5 ppm by weight. Unless otherwise specified, the drying step is carried out in an atmosphere in which the gas is continuously flowed or “swept” over the soot blank. In those embodiments where the atmosphere does not consist solely of CO, the atmosphere may further comprise at least one inert or relatively unreactive gas such as, but not limited to, helium, argon, nitrogen, neon, and the like.

The drying step, in one embodiment, is carried out in a substantially halogen-free atmosphere. As used herein, “substantially halogen-free” means that halogens (fluorine, chlorine, bromine, and iodine) are not intentionally added to the fused silica in either elemental form or as a halogen-containing compound. It is understood that the fused silica may inadvertently contain small amounts of halogen due to contamination. In one embodiment, the halogen-free atmosphere comprises from about 0.5% up to about 10% carbon monoxide. In one particular embodiment, the halogen-free atmosphere comprises about 1% CO. The mechanism for drying may be based on the reaction between CO and OH (or OD) to yield protium (or deuterium) and carbon dioxide.

Following drying of the soot blank with CO, the silica soot blank is heated at a temperature in a range from about 1000° C. up to about 1260° C. in an atmosphere comprising oxygen and an inert gas such as, but not limited to, helium. The oxygen should essentially be free of water. The oxygen concentration in the oxygen-helium mixture ranges from about 0.1% up to 100%. In one embodiment, the oxygen concentration is in a range from about 0.5% up to about 5%. In one particular embodiment, the dried soot blank is heated for one hour at 1225° C. in an atmosphere comprising 2% oxygen in helium. The sweeping of the dried soot blank with a mixture of oxygen and helium ensures complete conversion of CO to carbon dioxide (CO₂) and repairs any damage to the soot blank caused by CO drying. The oxygen sweep also re-oxidizes the silica and prevents formation of any oxygen-deficient centers.

The open porosity of the silica soot blank enables more effective drying and removal of water, hydroxyl, and deuteroxyl groups by carbon monoxide. Open porosity also allows the oxygen sweep to better permeate the soot blank and more effectively mitigate any damage to the silica caused by the CO drying step.

After the soot blank has been dried and optionally swept with an oxygen-helium mixture as described above, the dried silica soot blank is sintered or consolidated under conditions that are known in the art to form the fused silica glass article described herein. In one embodiment, the soot blank is consolidated at a temperature of up to about 1500° C. in an inert gas atmosphere containing from 0.5% up to 2% oxygen to form the fused silica glass article.

In order to obtain the desired final dimensions and shape, the consolidated fused silica glass article may optionally be re-worked by those means known in the art, such as, but not limited to, rolling out, squashing, and the like.

The consolidated fused silica glass article may optionally be loaded with at least one molecular hydrogen species—i.e., molecular protium, the mixed molecular species HD, and molecular deuterium—by heating the fused silica glass article in the presence of an atmosphere comprising hydrogen in its naturally occurring isotopic mixture (i.e., 99.98% protium, 0.02% deuterium) or hydrogen that has been enriched in either deuterium or protium. In one embodiment, the consolidated fused silica glass article is heated at a temperature of less than about 475° C., in some embodiments, at a temperature of less than about 450° C., in another embodiment, at a temperature of less than about 400° C., in another embodiment, at a temperature of less than about 370° C., and in still another embodiment, at a temperature less than or equal to about 350° C., and in a further embodiment at a temperature less than or equal to about 325° C., and in yet another embodiment at a temperature less than or equal to 300° C. and held at that temperature for a predetermined period of time and using a predetermined gas pressure with an atmosphere comprising H₂ with the balance being nitrogen to achieve the desired level of H₂ loading. In other embodiments in which the fused silica glass article comprises between 10 and 60 ppm OD by weight, in some embodiments, about 20 ppm by weight, in other embodiments, less than 60 ppm and greater than 1 ppm OD by weight, and in other embodiments less than 80 ppm OD, the consolidated fused silica glass article may be heated at about 425° C. and held for at that temperature for a predetermined period of time and using a predetermined gas pressure with an atmosphere comprising H₂ with the balance being nitrogen. After the specified time period at 425° C., the furnace is allowed to cool to room temperature.

At temperatures below about 500° C., molecular hydrogen species (i.e., H₂, HD, and D₂) are incorporated into fused silica with little reaction with the SiO₂ lattice. At temperatures greater than about 500° C., however, molecular hydrogen species react with the lattice, forming silicon hydride (SiH) or deuteride (SiD) and silicon hydroxide (SiOH) or deuteroxide (SiOD). Generally, as the initial hydroxyl (or deuteroxyl) content of the fused silica glass decreases and the temperature at which the fused silica is loaded with molecular hydrogen species increases, more reaction of the hydrogen species takes place, yielding more SiH and SiOH and/or SiD and SiOD. Loading of fused silica at temperatures of less than 500° C. is therefore preferable to minimize the generation of these species.

To achieve the OH and OD concentrations described herein, the method described hereinabove is carried out in a furnace (or furnaces) in which the amount of water (i.e., H₂O, D₂O, HDO) is maintained at low levels. The maintenance of low water levels within the furnace keeps the concentrations of OH and OD groups in the fused silica glass article below the desired levels. Small leaks within the furnace allow ambient air to enter the furnace, resulting in a significant partial pressure of water within the furnace. Accordingly, the amount of leakage of ambient air into the furnace must be minimized using those means known in the art. In one embodiment, such leakage is minimized or neutralized by maintaining the interior of the furnace at a pressure that is greater than ambient pressure, thus preventing or minimizing the ingress of water vapor into the furnace.

Optical materials used for deep ultraviolet (DUV) lithography applications have stringent specifications, and minor changes in performance can become significant. The fused silica glasses described herein provide an improvement in resistance to laser damage, as measured by laser induced wavefront distortion (LIWFD), of at least about 30%. Additionally, the fused silica glasses described herein provide an improvement in Fluence Dependent Transmission (FDT), as represented by dk/dh, of at least about approximately 50%. These improvements in LIWFD and FDT represent potential step changes in the performance of optical materials.

The following examples illustrate the features and advantages of the fused silica glasses described herein, and are in no way intended to limit the disclosure or appended claims thereto. In the following discussion, the H₂ loading procedure and characterization of the H₂ concentration are first described. The effect of 193 nm laser irradiation on wavefront distortion for specific samples is then described. Two series of samples were considered. The first series consisted of glass samples labeled 17395ALD1, 17395ALD2, 17395ALD3, and 17395ALD4. The second series consisted of glass samples 17119LDD1, 17119LDE1, and 17119LDE2. As described more fully hereinbelow, the first series of samples was loaded with H₂ at a higher temperature than the second series of samples. The concentrations of H₂, OH, and OD of each glass sample are discussed hereinbelow.

### H₂ Loading Procedure

The hydrogen loading process consisted of placing one or more glass articles into a furnace and heating in the presence of a gas ambient that includes H₂ gas. The furnace was equipped to expose the glass articles to gas ambients of variable compositions and pressures. In the present examples, the glass articles were placed in the furnace and heated to a selected temperature in a gas ambient consisting of an inert gas (e.g. N₂) and H₂. The glass articles were held in the gas ambient at the selected temperature for a time sufficient to achieve a targeted H₂ loading concentration. For a given selected temperature and size of glass article, the amount of time needed to achieve a particular H₂ loading concentration can be predetermined empirically or through a calibration procedure. The H₂ loading process can be performed at conditions of constant temperature, constant ambient gas pressure, and constant ambient gas composition. Alternatively, any of the conditions may be varied at predetermined times to achieve the targeted H₂ concentration profile. When the loading process was complete, the furnace was cooled and the glass articles were removed. Specific time and temperature conditions for each glass article are described hereinbelow.

In the preparation of each glass sample, H₂ loading was performed on an initial glass article having dimensions of 15×30×140 mm. As noted hereinabove, H₂ loading is a diffusion-controlled process and gradients in H₂ concentration are expected within the glass samples. Higher H₂ concentrations are expected at and near the surface and lower H₂ concentrations are expected in the interior. To minimize edge effects related to H₂ concentration gradients in the measurements that follow, 20 mm was removed from each end of each initial glass article after H₂ loading was completed. The resulting finished glass samples had dimensions of 15×30×100 mm and were the object of the exemplary studies described hereinbelow.

The initial glass articles for finished samples 17395ALD1 and 17395ALD2 were each loaded with H₂ to a centerline H₂ concentration of approximately 2.3×10¹⁷ molecules/cm³ under the following conditions: furnace temperature of 425° C., an ambient gas in the furnace consisting of an inert gas and 5.4% H₂, an ambient gas pressure of 250 psi (absolute) and a total H₂ loading time of 21 days.

The initial glass articles for finished samples 17395ALD3 and 17395ALD4 were each loaded with H₂ to a centerline H₂ concentration of approximately 0.5×10¹⁷ molecules/cm³ under the following conditions: furnace temperature of 425° C., an ambient gas in the furnace consisting of an inert gas and 4.0% H₂, and a total H₂ loading time of 10 days. The ambient gas pressure for the first 2.5 days was 265 psi (absolute), and for the last 7.5 days was 37 psi (absolute).

The initial glass articles for finished samples 17119LDE1 and 17119LDE2 were each loaded with H₂ to a centerline H₂ concentration of approximately 2.8×10¹⁷ molecules/cm³ consistent with the following conditions: furnace temperature of 350° C., an ambient gas in the furnace consisting of an inert gas and 5.4% H₂, an ambient gas pressure of 218 psi (absolute) and a total H₂ loading time of 28.5 days.

The initial glass articles for finished sample 17119LDD1 was loaded with H₂ to a centerline H₂ concentration of approximately 0.30×10¹⁷ molecules/cm³ under the following conditions: furnace temperature of 350° C., an ambient gas in the furnace consisting of an inert gas and 4% H₂, a gas pressure of 75 psi (absolute) and a total H₂ loading time of 14.5 day.

### H₂ Measurements and Results

After loading with H₂ and processing each glass article to form the finished glass samples, the H₂ concentration was measured along the path selected for subsequent exposure to 193 nm laser irradiation. The selected path traversed the 100 mm length dimension of the glass samples at or near the centerline. The H₂ concentration was measured at four positions along the 100 mm path length. In terms of distance from the incident surface of the glass sample, H₂ concentrations were measured at the following positions: 10 mm, 50 mm, 90 mm, and 97 mm. H₂ concentrations are expressed in units of H₂ molecules/cm³, which may also be expressed simply as molecules/cm³ where it is understood that the molecules referred to are H₂ molecules incorporated in the glass sample.

The interstitial molecular H₂ concentrations in the glass samples were determined using a Raman spectrometer (T64000 from Horiba Jobin Yvon Inc.). The H₂ concentration in the Raman measurement was calculated from the ratio of the intensity of the H₂ scattering peak at 4135 cm⁻¹ to the intensity of the silica matrix scattering peak at 800 cm⁻¹. The intensities of the above peaks were determined by integrating the areas under the peaks using a linear or quadratic fit to the background. The detection limit in the Raman system was 1×10¹⁶ H₂ molecules/cm³.

The four Raman centerline H₂ measurements for sample 17395ALD1 ranged from 2.10×10¹⁷ molecules/cm³ to 2.48×10¹⁷ molecules/cm³, with an average of 2.26×10¹⁷ molecules/cm³.

The four Raman centerline H₂ measurements for sample 17395ALD2 ranged from 1.91×10¹⁷ molecules/cm³ to 2.55×10¹⁷ molecules/cm³, with an average of 2.27×10¹⁷ molecules/cm³.

The four Raman centerline H₂ measurements for sample 17395ALD3 ranged from 0.34×10¹⁷ molecules/cm³ to 0.58×10¹⁷ molecules/cm³ with an average of 0.48×10¹⁷ molecules/cm³.

The four Raman centerline H₂ measurements for sample 17395ALD4 ranged from 0.33×10¹⁷ molecules/cm³ to 0.59×10¹⁷ molecules/cm³, with an average of 0.51×10¹⁷ molecules/cm³.

The four Raman centerline H₂ measurements for sample 17119LDD1 ranged from 0.19×10¹⁷ molecules/cm³ to 0.38×10¹⁷ molecules/cm³, with an average of 0.31×10¹⁷ molecules/cm³.

The four Raman centerline H₂ measurements for sample 17119LDE1 ranged from 2.63×10¹⁷ molecules/cm³ to 2.87×10¹⁷ molecules/cm³, with an average of 2.76×10¹⁷ molecules/cm³.

The four Raman centerline H₂ measurements for sample 17119LDE2 ranged from 2.81×10¹⁷ molecules/cm³ to 3.06×10¹⁷ molecules/cm³, with an average of 2.93×10¹⁷ molecules/cm³.

### Examples 1-7

In Examples 1-7, samples containing about 20 ppm OD by weight and reference samples containing less than about 6 ppm OH or OD by weight were subjected to “Marathon” exposures to 193 nm laser radiation. Four high purity fused silica glass articles for samples 17395ALD1, 17395ALD2, 17395ALD3, and 17395ALD4, were prepared using methods of making fused silica glass described in U.S. Pat. No. 8,012,894, by Dana Craig Bookbinder et al., filed May 5, 2008, and entitled “Glass Having Low OH, OD levels,” which claims priority from U.S. provisional patent application No. 60/928,471, filed May 9, 2007, and having the same title; and U.S. Pat. No. 8,062,986, by Rostislav Radiyevich Khrapko et al., filed Jul. 27, 2007, and entitled “Fused Silica Having Low OH, OD Levels and Method of Making;” The contents of the above-referenced patents are incorporated by reference herein in their entirety. These fused silica glass articles contained less than 5 ppb by weight of metal contaminants, less than 5 ppm by weight of OH groups, and about 20 ppm by weight of OD groups as characterized by ICP-MS and FTIR techniques, respectively. The related characterization techniques are described in U.S. Pat. No. 7,928,026 and U.S. Pat. No. 8,062,986, both of which are previously cited hereinabove. The processing conditions for the samples described in Examples 1-7 differ from those described in the above references only in that the OD content of the glass samples was controlled to be about 20 ppm. Otherwise, materials properties such as fictive temperatures and the like are inherently comparable to those of the fused silica reference materials described in the examples.

Marathon exposure testing with a 193 nm 4 kHz pulsed ArF Excimer laser (Lambda-Physik) on these samples was carried out at two different laser fluence levels (about 500 μJ/cm² and 200 μJ/cm²) and two different nominal pulse widths (about 24 ns and 80 ns). As used herein, nominal pulse width refers to the pulse width expected from the laser system. As is known in the art in practice, variations in pulse width during operation of laser systems occur due to normal instrumental limitations. In the laser system used for the Marathon exposure testing herein, a nominal pulse width of 24 ns is expected to have a variation in pulse width of about ±ns and a nominal pulse width of 80 ns is expected to have a variation in pulse width of about ±10 ns. Sample 17395ALD3, which had an average H₂ concentration of 0.48×10¹⁷ H₂ molecules/cm³, was exposed to laser radiation having a fluence of 500 μJ/cm² and pulse length of about 22 ns for 6 billion pulses in exposure segments of 1.5 billion pulses. Laser induced wavefront distortion (LIWFD) at 633 nm and 193 nm, H₂ concentration, and birefringence on the exposed spot in the sample were measured off-line between each exposure segment. Similarly, sample 17395ALD1, having an average H₂ concentration of 2.26×10¹⁷ H₂ molecules/cm³, was exposed to laser radiation having a fluence of 500 μJ/cm² and pulse length of about 87 ns laser beam for 6 billion pulses in exposure segments of 1.5 billion pulses. Sample 17395ALD2, having an average H₂ concentration of 2.4×10¹⁷ H₂ molecules/cm³, was exposed to laser radiation having a fluence of 200 μJ/cm² and pulse length of about 18 ns laser beam for 12 billion pulses in exposure segments of 3 billion pulses. Sample 17395ALD4, having an average H₂ concentration of 0.4×10¹⁷ H₂ molecules/cm³, was exposed to laser radiation having a fluence of 200 μJ/cm² and pulse length of about 22 ns for 9 billion of pulses in exposure segments of 3 billion pulses. The method and apparatus for measuring LIWFD at 633 nm and 193 nm are described in U.S. Pat. No. 7,928,026, referenced hereinabove, and SPIE Optical Microlithography XVI Vol. 5040, 1639-1650, the contents of which are incorporated herein by reference in their entirety. Specifically, such measurements were carried out using an 633 nm Zygo Verifire AT interferometer having a resolution of 50 μm/pixel, and a 193 nm Tropel Twyman-Green interferometer having a resolution of 75 μm/pixel, respectively. Normalized LIWFD values for all four samples (17395ALD1, 17395ALD2, 17395ALD3, 17395ALD4) are reported in Tables 1-9 below. In the tables, doses are expressed in units of (J²/cm⁴/ns)^{0.6}.

The Fluence Dependent Transmission (FDT) behavior of all samples was studied in terms of dk/dh value, which is defined as the slope of the linear fitting curve. Here k (1/cm) represents the transient absorption feature of the glass described hereinabove, and h is the fluence level expressed in mJ/cm² per pulse. FDT was measured by exposing the glass with up to 1 million pulses of 193 nm laser irradiation having a fluence of about 1 mJ/cm² per pulse to about 10 mJ/cm² per pulse with a repetition rate of 400 Hz. Internal transmission (Tᵢ) values (˜99.7%/cm) for all four samples (17395ALD1, 17395ALD2, 17395ALD3, 17395ALD4) are consistent with previous findings for this type of glass that have been loaded with H₂ at temperatures of less than 400° C. All four samples (17395ALD1, 17395ALD2, 17395ALD3, 17395ALD4) exhibited dk/dh values of less than 1.4×10⁵ cm-pulse/mJ.

### Example 1

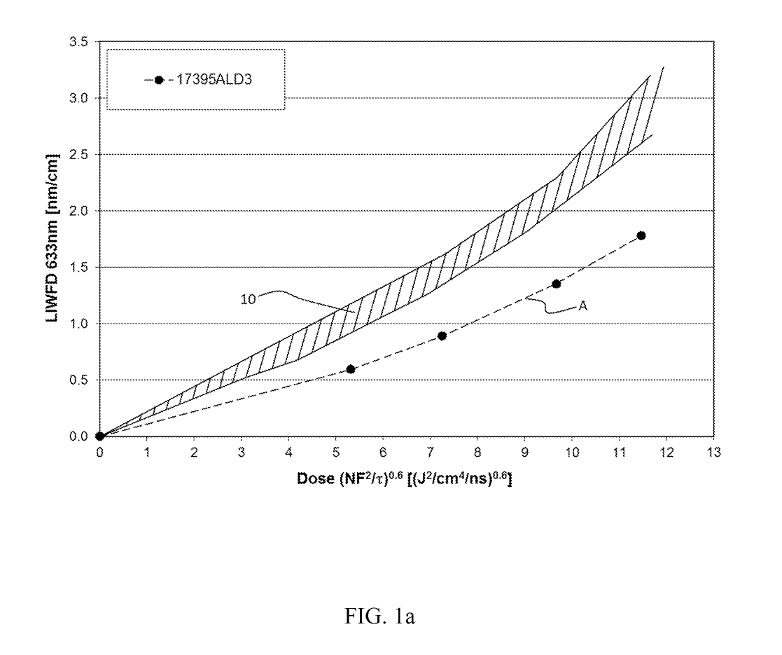

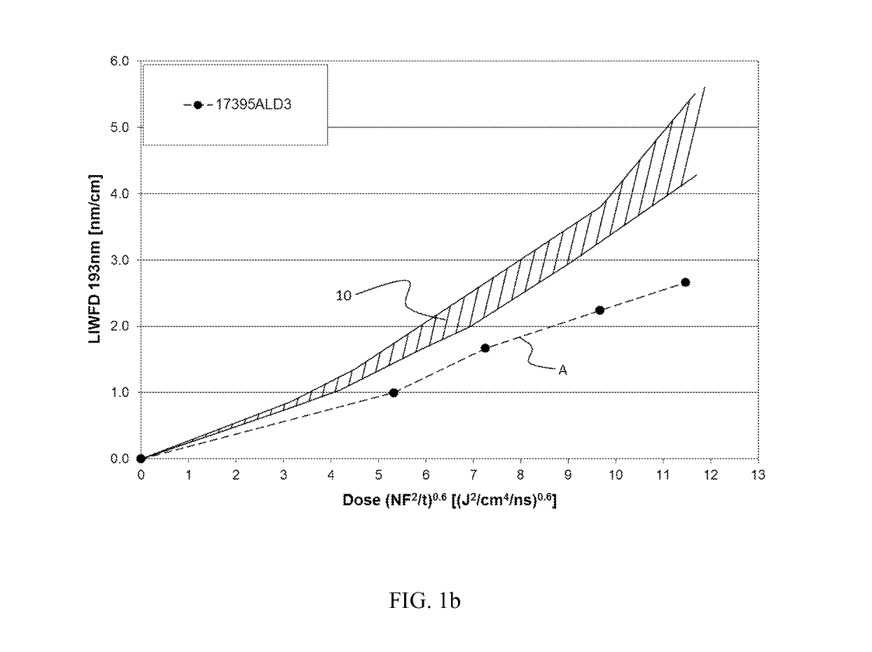

Sample 17395ALD3, which contained approximately 20 ppm OD by weight, and reference material comprising similarly soot-formed, high purity fused silica, containing less than 6 ppm OH and OD, and loaded to a similar hydrogen content at a temperature of 425° C. were Marathon exposed using a 193 nm laser having a laser fluence of approximately 500 μJ/cm² and a laser pulse width of about 22 ns. The laser resistance performance of sample 17395ALD3 was much improved over that of the reference material. Examples of the improved LIWFD of sample 17395ALD3 as measured using a 633 nm and 193 nm interferometers are shown in FIGS. 1a and 1b, respectively. In each of these figures, the hatched area 10 represents the range of values measured for reference samples and line A represents the LIWFD measured for sample 17395ALD3.

Tables 1-3 list hydrogen loading temperature, hydrogen concentrations, OD or OH concentrations, conditions for Marathon laser exposure, LIWFD measured at 633 nm and 193 nm, and FDT determined for sample 17395ALD3 and reference material, and the percentage improvement in performance achieved by sample 17395ALD3 with respect to the reference material. Sample 17395ALD3 exhibited an improvement of 31 to 48% in LIWFD over the reference materials in measurements using 633 nm radiation. Similarly, sample 17395ALD3 exhibited an improvement ranging from 20 to 52% in LIWFD over the reference material when 193 nm laser light was used.

TABLE 1
Data Summary for sample 17395ALD3
and reference fused silica samples.

| | H₂ | Average | | | Pulse |
|---|---|---|---|---|---|
| | Loading | H₂ | OH/OD | Fluence | width |
| Sample | Temp (° C.) | (10¹⁷ cm⁻³) | (ppm) | (μJ/cm²) | (ns) |
| 17395ALD3 | 425 | 0.48 | ~20 OD | 492 | 22 |
| References | 425 | 0.3-0.5 | <6 | 466-545 | 19-24 |

TABLE 2
Data Summary for sample 17395ALD3 and reference fused silica samples.

| | LIWFD 633 (nm/cm) | | | LIWFD 193 (nm/cm) | | |
|---|---|---|---|---|---|---|
| Sample | Dose = 6 | Dose = 9 | Dose = 12 | Dose = 6 | Dose = 9 | Dose = 12 |
| 17395ALD3 | 0.72 | 1.25 | 1.80 | 1.30 | 2.10 | 2.80 |
| References | 1.04-1.35 | 1.81-2.25 | 2.70-3.45 | 1.65-2.00 | 2.95-3.65 | 4.30-5.80 |
| Improvement (%) | 31-47 | 31-44 | 33-48 | 20-35 | 29-42 | 35-52 |

TABLE 3
Data Summary for sample 17395ALD3
and reference fused silica samples.

| | FDT (dk/dh) |
|---|---|
| Sample | (10⁻⁶ cm-pulse/mJ) |
| 17395ALD3 | 8.71 |
| References | 14.9-22 |
| Improvement (%) | 42-60 |

### Example 2

Sample 17395ALD1, which contained approximately 20 ppm OD by weight, and a reference material (reference 1) of similarly soot-formed, high purity fused silica having OH and/or OD content of less than 6 ppm by weight, metal content of less than 5 ppb by weight and loaded to a hydrogen content comparable to that of sample 17395ALD1 at a temperature of 425° C. was “Marathon” exposed using a 193 nm laser with a laser fluence of approximately 500 μJ/cm² and a laser pulse width of about 80 ns. The laser resistance performance of sample 17395ALD1 was much improved over that of the reference materials (Tables 4-6). Hydrogen loading temperature, hydrogen concentration, OD and/or OH concentrations, conditions for Marathon laser exposure, LIWFD measured at 633 nm and 193 nm, FDT determined for 17395ALD1 and reference materials 1 and 2 and the percentage improvement in performance achieved by sample 17395ALD1 with respect to the reference materials are summarized in Tables 4-6. Table 5 shows that, for measurements made using 633 nm laser radiation, sample 17395ALD1 exhibited an improvement in LIWFD ranging from 28% to 36% improvement over the LIWFD of the reference materials. Similarly, for measurements made using 193 nm laser radiation, sample 17395ALD1 exhibited an improvement in LIWFD ranging from 20 to 38% over the LIWFD of the reference materials.

Tables 4-6 also show a comparison of LIWFD for sample 17395ALD1 in measurements made at 633 nm and a second reference sample (reference 2) similarly soot-formed high purity fused silica containing less than 6 ppm of OH and OD and less than 5 ppb of metals. Reference 2 was loaded to a lower hydrogen concentration (about 0.4×10¹⁷ H₂ molecules/cm³) than sample 17395ALD1 at a temperature of 425° C. The results obtained for sample 17395ALD1 are similar to those obtained for the reference 2 material. Since fused silica containing less H₂ typically exhibits lower LIWFD, the LIWFD observed for sample 17395ALD1, having a higher hydrogen concentration, represents an unexpected increase in resistance to laser radiation.

TABLE 4
Data Summary for sample 17395ALD1
and reference fused silica samples.

| | H₂ | Average | | | Pulse |
|---|---|---|---|---|---|
| | Loading | H₂ | OH/OD | Fluence | width |
| Sample | Temp (° C.) | (10¹⁷ cm⁻³) | (ppm) | (μJ/cm²) | (ns) |
| 17395ALD1 | 425 | 2.26 | ~20 OD | 469 | 87 |
| Reference 1 | 425 | 2.88 | <6 | 476 | 84 |
| Reference 2 | 425 | 0.41-0.43 | <6 | 460-480 | 66-83 |

TABLE 5
Data Summary for sample 17395ALD1 and reference fused silica samples.

| | LIWFD 633 (nm/cm) | | | LIWFD 193 (nm/cm) | | |
|---|---|---|---|---|---|---|
| Sample | Dose = 2.5 | Dose = 4 | Dose = 5.5 | Dose = 2.5 | Dose = 4 | Dose = 5.5 |
| 17395ALD1 | 0.45 | 0.78 | 1.30 | 0.80 | 1.50 | 2.00 |
| Reference 1 | 0.70 | 1.20 | 1.80 | 1.00 | 1.75 | 3.25 |
| Reference 2 | 0.51 | 0.78-0.79 | 1.25-1.40 | 0.75 | 1.2 | 2.3 |
| Improvement (%) | 36 | 35 | 28 | 20 | 29 | 38 |

TABLE 6
Data Summary for sample 17395ALD1
and reference fused silica samples.

| | FDT (dk/dh) |
|---|---|
| Sample | (10⁻⁶ cm-pulse/mJ) |
| 17395ALD1 | 11.7 |
| Reference 1 | 24.7 |
| Reference 2 | 18-28 |
| Improvement (%) | 53 |

### Example 3

Sample 17395ALD4, which contained approximately 20 ppm OD by weight and was loaded with an average H₂ concentration of 0.51×10¹⁷ H₂ molecules/cm³ at 425° C., and reference material of similarly soot-formed, high purity fused silica having OH and/or OD content of less than 6 ppm by weight, metal content of less than 5 ppb by weight, and loaded to a hydrogen concentration of 0.4-0.62×10¹⁷ H₂ molecules/cm³ at a temperature of 425° C. were “Marathon” exposed using a 193 nm laser with a laser fluence of approximately 200 μJ/cm² and a laser pulse width of 22 ns. The laser resistance performance of sample 17395ALD4 was much improved over that of the reference materials (Tables 7-9). Hydrogen loading temperature, hydrogen concentration, OD and/or OH concentrations, conditions for Marathon laser exposure, LIWFD measured at 633 nm and 193 nm, FDT determined for sample 17395ALD4 and the reference material, and the percentage improvement in performance achieved by sample 17395ALD4 with respect to the reference material are summarized in Tables 7-9. As seen in Table 8, the LIWFD observed for sample 17395ALD4 represents a 25 to 50% improvement over the LIWFD of the reference materials for measurements made using 633 nm laser radiation. Similarly, sample 17395ALD4 exhibited an improvement in LIWFD of 15 to 42% when measured using 193 nm laser radiation.

### Example 4

Sample 17395ALD2, which contained approximately 20 ppm OD by weight and was loaded with an average H₂ concentration of 2.27×10¹⁷ H₂ molecules/cm³ at 425° C., was Marathon exposed using 193 nm laser with a laser fluence of approximately 200 μJ/cm² and a laser pulse width of 18 ns. The results of LIWFD measurements obtained from Marathon testing at 633 nm and 193 nm are listed in Tables 7-9. The results obtained for sample 17395ALD2 are similar to those obtained for the reference material listed in Tables 7-9. Since fused silica containing less H₂ typically exhibits lower LIWFD, however, the LIWFD observed for sample 17395ALD2, which has a higher hydrogen concentration than the reference material, represents an unexpected increase in resistance to laser radiation. In other words, samples containing about 20 ppm OD do not exhibit the sensitivity of LIWFD to higher H₂ content of fused silica glass.

TABLE 7
Data Summary for samples 17395ALD2, 17395ALD4,
and reference fused silica samples.

| | H₂ | Average | | | Pulse |
|---|---|---|---|---|---|
| | Loading | H₂ | OH/OD | Fluence | width |
| Sample | Temp (° C.) | (10¹⁷ cm⁻³) | (ppm) | (μJ/cm²) | (ns) |
| 17395ALD2 | 425 | 2.27 | ~20 OD | 175 | 18 |
| 17395ALD4 | 425 | 0.51 | ~20 OD | 211 | 22 |
| References | 425 | 0.40-0.62 | <6 | 189-200 | 23-25 |

TABLE 8
Data Summary for samples 17395ALD2, 17395ALD4, and
reference fused silica samples.

| | LIWFD 633 (nm/cm) | | | LIWFD 193 (nm/cm) | | |
|---|---|---|---|---|---|---|
| Sample | Dose = 3 | Dose = 4 | Dose = 5 | Dose = 3 | Dose = 4 | Dose = 5 |
| 17395ALD2 | 0.60 | 0.80 | 1.20 | 1.10 | 1.50 | 2.10 |
| 17395ALD4 | 0.43 | 0.60 | 0.70 | 0.68 | 1.10 | 1.40 |
| References | 0.60-0.70 | 0.80-1.20 | 1.25-1.80 | 0.80-1.00 | 1.50-1.75 | 2.20-2.40 |
| Improvement (%) | 28-39 | 25-50 | 44-50 | 15-32 | 27-37 | 36-42 |

TABLE 9
Data Summary for samples 17395ALD2, 17395ALD4,
and reference fused silica samples.

| | FDT (dk/dh) |
|---|---|
| Sample | (10⁻⁶ cm-pulse/mJ) |
| 17395ALD2 | 10.4 |
| 17395ALD4 | 7.81 |
| References | 15-22 |
| Improvement (%) | 48-65 |

### Example 5

The material described in Example 1 (sample 17395ALD3) was tested for dk/dh by FDT and was found to have a dk/dh value of 8.71×10⁻⁶ cm·pulse/mJ. As seen in Table 3, this value is significantly less than the value of 14.9−22×10⁻⁶ cm·pulse/mJ obtained for reference materials having a comparable hydrogen concentration and loaded with H₂ at a temperature of 425° C.

### Example 6

Sample 17395ALD1, described in Example 2 above, was tested for dk/dh by FDT. The sample had a dk/dh value of 11.7×10⁻⁶ cm·pulse/mJ. As seen in Table 6, this value is much lower than the dk/dh value of 24.7×10⁻⁶ cm·pulse/mJ observed for the reference material, which was loaded to a similar hydrogen concentration at a temperature of 425° C.

### Example 7

Sample 17395ALD4 described in Example 3 above was tested for dk/dh by FDT, and was found to have a dk/dh value of 7.81×10⁻⁶ cm·pulse/mJ. As seen in Table 9, this value is much lower than the dk/dh value of 15 to 22×10⁻⁶ cm·pulse/mJ observed for the reference material, which was loaded to a similar hydrogen concentration at a temperature of 425° C.

### Examples 8-10

In examples 8-10, high purity fused silica samples that were loaded with molecular hydrogen at 350° C. were subjected to Marathon laser exposure. Three high purity fused silica glass articles for samples 17119LDD1, 17119LDE1, and 17119LDE2 were prepared using methods of making fused silica glass described in U.S. Pat. Nos. 8,012,894 and 8,062,986, and were characterized as described in U.S. Pat. No. 7,928,026, all of which have been previously described and referenced hereinabove. These three fused silica glass samples contained less than 5 ppb by weight of metal contaminants and less than 5 ppm by weight of OH and/or OD groups. The processing conditions for the samples described in Examples 8-10 differ from those described in the above references only in that samples 17119LDD1, 17119LDE1, and 17119LDE2 were loaded with molecular hydrogen at 350° C. to obtain a predetermined H₂ distribution pattern in a typical laser damage sample having dimensions of 100 mm×30 mm×15 mm. Different combinations of H₂ purity and loading pressure resulted in different H₂ distributions in individual samples, and different sample sizes resulted in different H₂ loading times. Interstitial H₂ concentrations were determined by Raman spectroscopy, as previously described hereinabove. Otherwise, materials properties such as fictive temperatures and the like are inherently comparable to those of the fused silica reference materials described in the examples.

Marathon exposure testing with a 193 nm 4 kHz pulsed ArF Excimer laser (Lambda-Physik) on these samples was carried out at two different laser fluence levels (about 500 μJ/cm² and 200 μJ/cm²) and two different nominal pulse widths (about 24 ns and 80 ns). As used herein, nominal pulse width refers to the pulse width expected from the laser system. As is known in the art in practice, variations in pulse width during operation of laser systems occur due to normal instrumental limitations. In the laser system used for the Marathon exposure testing herein, a nominal pulse width of 24 ns is expected to have a variation in pulse width of about ±5 ns and a nominal pulse width of 80 ns is expected to have a variation in pulse width of about ±10 ns. Sample 17119LDD1, which had an average H₂ concentration along the testing beam path (do we want to add statements like this, since this is the average where we tested, but not the overall ‘global’ average of what was in the part as a whole?) of 0.30×10¹⁷ H₂ molecules/cm³), was exposed to laser radiation having a fluence of 500 μJ/cm² and pulse length of about 24 ns for 6 billion pulses in 1.5 billion pulse exposure segments. For all samples described herein, laser induced wavefront distortion (LIWFD) at 633 nm and 193 nm, H₂ concentration, and birefringence on the exposed spot in the sample were measured off-line between each exposure segment. Similarly, sample 17119LDE1, having an average H₂ concentration of 2.7×10¹⁷ H₂ molecules/cm³, was exposed to laser radiation having a fluence of 500 μJ/cm² and pulse length of about 80 ns laser beam for 6 billion pulses in 1.5 billion pulse exposure segments. Sample 17119LDE2, having an average H₂ concentration of 2.8×10¹⁷ H₂ molecules/cm³, was exposed to laser radiation having a fluence of 200 μJ/cm² and pulse length of about 24 ns laser beam for 12 billion pulses in 3 billion pulse exposure segments. LIWFD was measured at 633 nm and 193 nm using the method and apparatus previously described and reference herein. The measurements yielded bulk LIWFD values which were then normalized to allow comparison of results obtained using different fluences, pulse rates, and numbers of pulses.

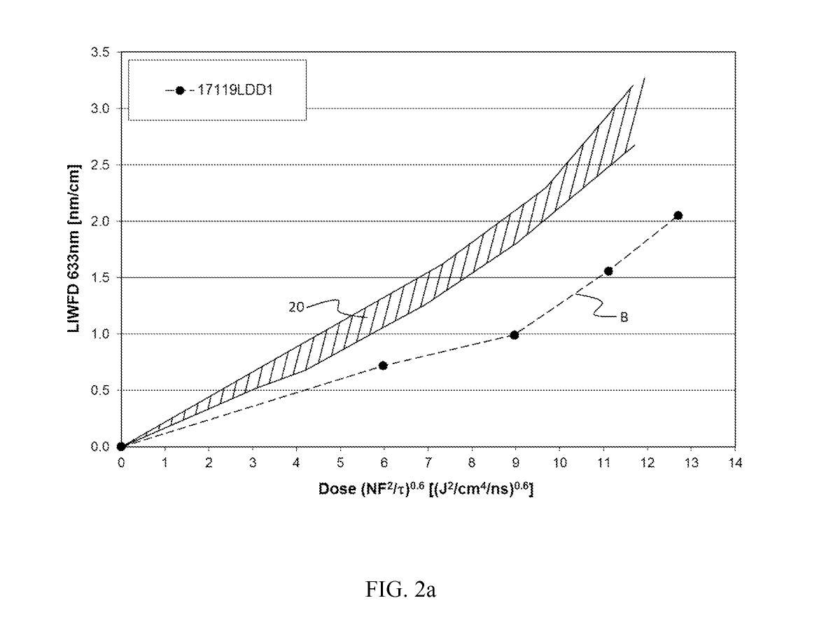

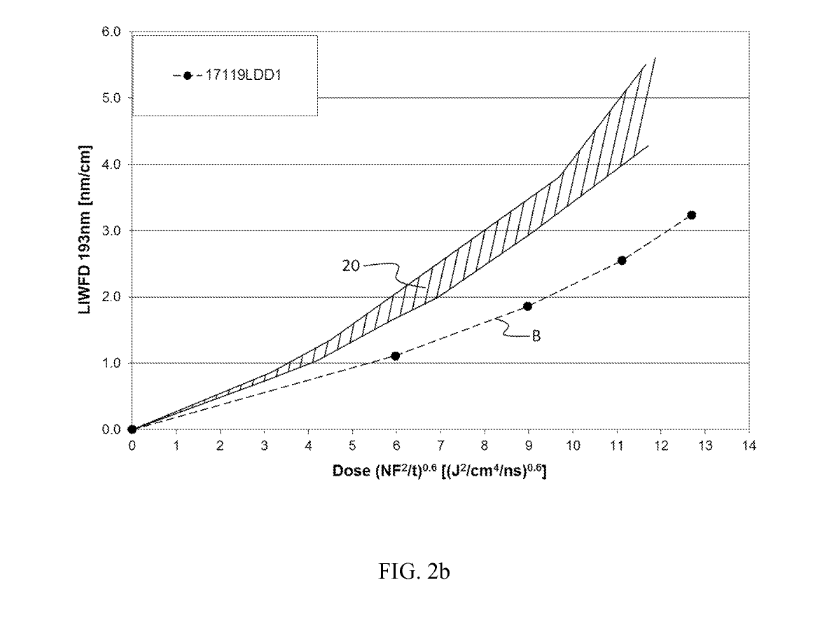

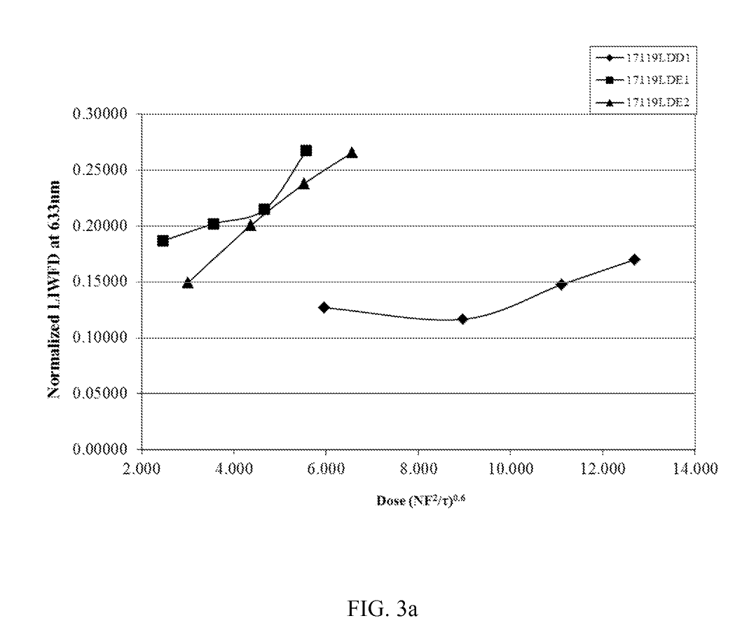

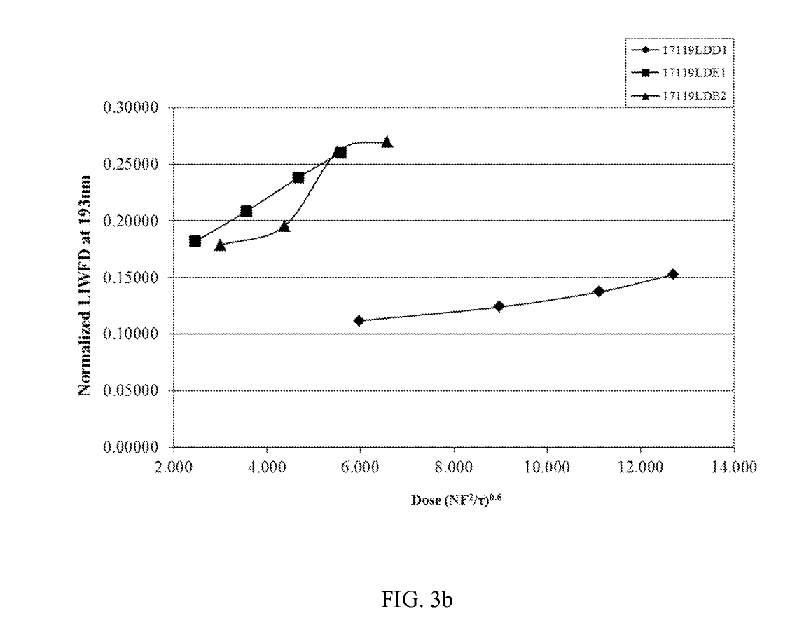

Bulk LIWFD for measurements made at 633 nm and 193 nm are plotted as functions of dose in FIGS. 2a and 2b, respectively, for sample 17119LDD1. As seen from FIGS. 2a and 2b, the bulk LIWFD measured for sample 17119LDD1 (line B in FIGS. 2a and 2b) represents an improvement of at least about 30% compared to similar measurements (area 20 in FIGS. 2a and 2b) performed on other reference samples. Data for samples 17119LDD1, 17119LDE1, and 17119LDE2 are summarized Tables 10-18 below, which include estimated compaction improvement over reference samples under similar conditions; i.e. H₂ concentration, exposure parameters, etc. The data listed in Tables 16-18 clearly indicate that sample 17119LDE2, which was loaded at low temperature and had a higher H₂ concentration than the reference materials, performed well in comparison to materials loaded with molecular hydrogen at 425° C. and having lower H₂ concentrations. In other words, hydrogen loading at 350° C. reduced the sensitivity of LIWFD performance to H₂ concentration of the fused silica glass. FIGS. 3a and 3b are plots of normalized LIWFD at 633 nm and 193 nm for samples 17119LDD1, 17119LDE2, and 17395ALD4. The normalized values at the end of laser exposure for sample 17119LDD1 are 0.17 nm/cm and 0.15 nm/cm, respectively.

Fluence Dependent Transmission (FDT) behavior of samples 17119LDD1, 17119LDE1, and 17119LDE2 had dk/dh values of less than 1.3×10⁻⁵ cm-pulse/mJ, which are the best reported to date for fused silica glass. Estimated FDT improvement with respect to dk/dh values measured for reference samples can be directly compared in Tables 12, 15 and 18.

### Example 8

Sample 17119LDD1, a 15×30×100 mm sample of soot-formed high purity fused silica glass having a combined OH/OD content of less than 10 ppm and metal content of less than 5 ppb by weight.

Sample 17119LDD1 was Marathon exposed using a 193 nm laser with a fluence of approximately 500 μJ/cm² and a laser pulse width of 24 ns. The laser resistance performance of the sample was much improved over reference measurements made on similarly soot-formed high purity fused silica that was H₂ loaded at a temperature of 425° C. to a similar hydrogen content. Examples of the improved LIWFD performance as measured using a 633 nm and 193 nm interferometers are shown in FIGS. 3a and 3b, respectively. The hatched area 20 in each figure represents the range of values obtained for reference sample measurements, and line B in each figure represents the LIWFD values obtained for sample 17119LDD1.

Table 11 shows that the LIWFD of sample 17119LDD1 improved by 31% to 56% improvement over the LIWFD of the reference materials when the measured using 633 nm laser radiation. Similarly, the LIWFD improvement was 33 to 50% when measured using 193 nm laser radiation.

As seen in Table 12, sample 17119LDD1 has a dk/dh value when tested by FDT of 7.91×10⁻⁶ cm·pulse/mJ, which is significantly less than the values of 14.9 to 22×10⁻⁶ cm·pulse/mJ observed for reference materials loaded with comparable amounts of molecular hydrogen at a temperature of 425° C.

TABLE 10
Data Summary for sample 17119LDD1
and reference fused silica samples.

| | H₂ | Average | | Pulse |
|---|---|---|---|---|
| | Loading | H₂ | Fluence | width |
| Sample | Temp (° C.) | (10¹⁷ cm⁻³) | (μJ/cm²) | (ns) |
| 17119LDD1 | 350 | 0.31 | 565 | 24 |
| References | 425 | 0.3-0.5 | 466-545 | 19-24 |

TABLE 11
Data Summary for sample 17119LDD1 and reference fused silica samples.

| | LIWFD 633 (nm/cm) | | | LIWFD 193 (nm/cm) | | |
|---|---|---|---|---|---|---|
| Sample | Dose = 6 | Dose = 9 | Dose = 12 | Dose = 6 | Dose = 9 | Dose = 12 |
| 17119LDD1 | 0.72 | 0.99 | 1.75 | 1.11 | 1.86 | 2.90 |
| References | 1.04-1.35 | 1.81-2.25 | 2.70-3.45 | 1.65-2.00 | 2.95-3.65 | 4.30-5.80 |
| Improvement (%) | 31-47 | 45-56 | 35-49 | 33-44 | 37-49 | 33-50 |

TABLE 12
Data Summary for sample 17119LDD1
and reference fused silica samples.

| | FDT (dk/dh) |
|---|---|
| Sample | (10⁻⁶ cm-pulse/mJ) |
| 17119LDD1 | 7.91 |
| References | 14.9-22 |
| Improvement (%) | 47-64 |

### Example 9

Sample 17119LDE1, a 15×30×100 mm sample of soot-formed high purity fused silica glass having a combined OH/OD content of less than 10 ppm and metal content of less than 5 ppb by weight.

When sample 17119LDE1 was Marathon exposed using 193 nm laser with a laser fluence of approximately 500 μJ/cm² and a laser pulse width of 80 ns, the laser resistance performance of the sample was much improved over that of similarly soot-formed high purity fused silica material (labeled “Reference 1” in Tables 13-15) that had been loaded to a comparable hydrogen content at a temperature of 425° C. and having an OH content of less than 10 ppm and a metal content less than 5 ppm by weight. The results of LIWFD and FDT measurements on sample 17119LDE1 and the reference materials are summarized in Tables 14 and 15. As seen in Table 14, the LIWFD performance of sample 17119LDE1 represented an improvement of 22 to 37% over the LIWFD of the reference material when measured using 633 nm laser radiation. Similarly, the improvement in LIWFD was 14 to 26% when measured using 193 nm laser radiation.

Table 14 of FIG. 4 also includes a comparison of LIWFD measured at 633 nm for sample 17119LDE1 to similarly soot formed high purity fused silica (“Reference 2” in Tables 13-15) that had been loaded to a lower hydrogen content (about 0.4×10¹⁷ H₂ molecules/cm³) at a temperature of 425° C. and having an OH content of less than 10 ppm and a metal content of less than 5 ppm by weight. The results obtained for 17119LDE1 are similar to those obtained for the Reference 2 material, which, because fused silica having a lower H₂ content typically has lower LIWFD, represents an unexpected improvement in laser performance for sample 17119LDE1.

As seen in Table 15, sample 17119LDE1 has a dk/dh value tested by FDT of 7.84×10⁻⁶ cm·pulse/mJ, which is significantly less than the value of 24.7×10⁻⁶ cm·pulse/mJ observed for reference materials loaded with a comparable amount of molecular hydrogen at a temperature of 425° C.

TABLE 13
Data Summary for sample 17119LDE1
and reference fused silica samples.

| | H₂ | Average | | Pulse |
|---|---|---|---|---|
| | Loading | H₂ | Fluence | width |
| Sample | Temp (° C.) | (10¹⁷ cm⁻³) | (μJ/cm²) | (ns) |
| 17119LDE1 | 350 | 2.76 | 500 | 80 |
| Reference1 | 425 | 2.88 | 476 | 84 |
| Reference2 | 425 | 0.41-0.43 | 460-480 | 66-83 |

TABLE 14
Data Summary for sample 17119LDE1 and reference fused silica samples.

| | LIWFD 633 (nm/cm) | | | LIWFD 193 (nm/cm) | | |
|---|---|---|---|---|---|---|
| Sample | Dose = 2.5 | Dose = 4 | Dose = 5.5 | Dose = 2.5 | Dose = 4 | Dose = 5.5 |
| 17119LDE1 | 0.44 | 0.78 | 1.40 | 0.75 | 1.50 | 2.40 |
| Reference1 | 0.70 | 1.20 | 1.80 | 1.00 | 1.75 | 3.25 |
| Reference2 | 0.51 | 0.78-0.79 | 1.25-1.40 | | | |
| Improvement (%) | 37 | 35 | 22 | 25 | 14 | 26 |

TABLE 15
Data Summary for sample 17119LDE1
and reference fused silica samples.

| | FDT (dk/dh) |
|---|---|
| Sample | (10⁻⁶ cm-pulse/mJ) |
| 17119LDE1 | 7.84 |
| Reference1 | 24.7 |
| Reference2 | 18-28 |
| Improvement (%) | 68 |

### Example 10

Sample 17119LDE2, a 15×30×100 mm sample of soot-formed high purity fused silica glass having a combined OH and OD content of less than 10 ppm and a metal content less than 5 ppm by weight.

When sample 17119LDE2 was Marathon exposed using 193 nm laser with a laser fluence of approximately 200 μJ/cm² and a laser pulse width of 24 ns, the laser resistance performance of the sample was much improved over reference measurements made on similarly soot-formed high purity fused silica material that had been loaded to a lower hydrogen content (about 0.4×10¹⁷ to 0.6×10¹⁷ H₂ molecules/cm³) at a temperature of 425° C. and having an OH content of less than 10 ppm and a metal content less than 5 ppm by weight. The results of LIWFD and FDT measurements on sample 17119LDE1 and the reference materials are summarized in Tables 16-18 below. The LIWFD results obtained for 17119LDE2 are similar to those obtained for the reference material. Because fused silica having a lower H₂ content typically exhibits lower LIWFD, the results obtained for sample 17119LDE1 represent an unexpected improvement in laser performance for this sample. In other words, the sensitivity of LIWFD performance to higher H₂ concentration is decreased by hydrogen loading at lower (in this instance, 350° C.) temperatures.

TABLE 16
Data Summary for sample 17119LDE2
and reference fused silica samples.

| | H₂ | Average | | Pulse |
|---|---|---|---|---|
| | Loading | H₂ | Fluence | width |
| Sample | Temp (° C.) | (10¹⁷ cm⁻³) | (μJ/cm²) | (ns) |
| 17119LDE2 | 350 | 2.93 | 221 | 24 |
| References | 425 | 0.40-0.62 | 189-200 | 23-25 |

TABLE 17
Data Summary for sample 17119LDE2 and reference fused silica samples.

| | LIWFD 633 (nm/cm) | | | LIWFD 193 (nm/cm) | | |
|---|---|---|---|---|---|---|
| Sample | Dose = 3 | Dose = 4 | Dose = 5 | Dose = 3 | Dose = 4 | Dose = 5 |
| 17119LDE2 | 0.43 | 0.85 | 1.25 | 0.90 | 1.45 | 2.41 |
| References | 0.60-0.70 | 0.80-1.20 | 1.25-1.80 | 0.80-1.00 | 1.50-1.75 | 2.20-2.40 |

TABLE 18
Data Summary for sample 17119LDE2
and reference fused silica samples.

| | FDT (dk/dh) |
|---|---|
| Sample | (10⁻⁶ cm-pulse/mJ) |
| 17119LDE2 | 12.1 |
| References | 15-22 |

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

What is claimed is:

1. A method of treating a fused silica glass article comprising:
providing a fused silica glass article, said fused silica glass article including a combined concentration of OH and OD groups of less than or equal to 60 ppm, said fused silica glass article being free of chlorine and fluorine; and
heating said fused silica glass article in a gas atmosphere, said gas atmosphere comprising H₂, said heating occurring at a temperature less than or equal to 400° C., said heating inducing transfer of H₂ into said fused silica glass article to form a H₂-loaded fused silica glass article, said H₂-loaded fused silica glass article containing a minimum concentration of H₂ of at least 1×10¹⁶ H₂ molecules/cm³ throughout said H₂-loaded fused silica glass article

2. The method of claim 1, wherein said fused silica glass article includes a combined concentration of OH and OD groups of greater than 10 ppm.

3. The method of claim 1, wherein said H₂-loaded fused silica glass article has a laser induced wavefront distortion of less than 1.7 nm/cm measured at 633 nm and less than 3.0 nm/cm measured at 193 nm after exposure to 6 billion pulses of 193 nm wavelength laser radiation at a fluence of 500 μJ/cm² per pulse and a nominal pulse width of 80 ns.

4. The method of claim 3, wherein said H₂-loaded fused silica glass article contains a minimum concentration of H₂ of at least 5×10¹⁶ H₂ molecules/cm³ throughout said H₂-loaded fused silica glass article.

5. The method of claim 3, wherein said H₂-loaded fused silica glass article contains a minimum concentration of H₂ of at least 1×10¹⁷ H₂ molecules/cm³ throughout said H₂-loaded fused silica glass article.

6. The method of claim 2, wherein said H₂-loaded fused silica glass article contains a minimum concentration of H₂ of at least 2×10¹⁷ H₂ molecules/cm³ throughout said H₂-loaded fused silica glass article and said H₂-loaded fused silica glass article has a laser induced wavefront distortion of less than 1.7 nm/cm measured at 633 nm and less than 3.0 nm/cm measured at 193 nm after exposure to 12 billion pulses of 193 nm wavelength laser radiation at a fluence of 200 μJ/cm² per pulse and a nominal pulse width of 18 ns.

7. The method of claim 1, wherein said fused silica glass article includes a combined concentration of OH and OD groups of less than 5 ppm.

8. The method of claim 1, wherein said fused silica glass article includes a combined concentration of OH and OD groups of less than 1 ppm.

9. The method of claim 1, wherein said fused silica glass article includes a combined concentration of OH and OD groups of less than 10 ppm.

10. The method of claim 9, wherein said heating occurs at a temperature of less than or equal to 350° C.

11. The method of claim 10, wherein said H₂-loaded fused silica glass article has a laser induced wavefront distortion of less than 2.7 nm/cm measured at 633 nm and less than 3.7 nm/cm measured at 193 nm after exposure to 6 billion pulses of 193 nm wavelength laser radiation at a fluence of 500 μJ/cm² per pulse and a nominal pulse width of 24 ns.

12. The method of claim 11, wherein said fused silica glass article includes a combined concentration of OH and OD groups of less than 5 ppm.

13. The method of claim 11, wherein said fused silica glass article includes a combined concentration of OH and OD groups of less than 1 ppm.

14. The method of claim 11, wherein said H₂-loaded fused silica glass article contains a minimum concentration of H₂ of at least 1×10¹⁷ H₂ molecules/cm³ throughout said H₂-loaded fused silica glass article.

15. The method of claim 10, wherein said H₂-loaded fused silica glass article contains a minimum concentration of H₂ of at least 2×10¹⁷ H₂ molecules/cm³ throughout said H₂-loaded fused silica glass article and said H₂-loaded fused silica glass article has a laser induced wavefront distortion of less than 1.7 nm/cm measured at 633 nm and less than 3.0 nm/cm measured at 193 nm after exposure to 6 billion pulses of 193 nm wavelength laser radiation at a fluence of 500 μJ/cm² per pulse and a nominal pulse width of 80 ns.

16. The method of claim 15, wherein said fused silica glass article includes a combined concentration of OH and OD groups of less than 5 ppm.

17. The method of claim 15, wherein said fused silica glass article includes a combined concentration of OH and OD groups of less than 1 ppm.

18. The method of claim 12, wherein said H₂-loaded fused silica glass article contains a minimum concentration of H₂ of at least 2×10¹⁷ H₂ molecules/cm³ throughout said H₂-loaded fused silica glass article and said H₂-loaded fused silica glass article has a laser induced wavefront distortion of less than 1.7 nm/cm measured at 633 nm and less than 3.0 nm/cm measured at 193 nm after exposure to 12 billion pulses of 193 nm wavelength laser radiation at a fluence of 200 μJ/cm² per pulse and a nominal pulse width of 24 ns.

19. The method of claim 18, wherein said fused silica glass article includes a combined concentration of OH and OD groups of less than 5 ppm.

20. The method of claim 18, wherein said fused silica glass article includes a combined concentration of OH and OD groups of less than 1 ppm.
